(19) United States
(12) Patent Application Publication
(10) Pub. No.: US 2025/0384388 A1
(43) Pub. Date: Dec. 18, 2025

(54) INFORMATION PROCESSING SYSTEM, INFORMATION PROCESSING DEVICE, INFORMATION PROCESSING METHOD, AND PROGRAM

(71) Applicant: AERONEXT INC., Tokyo (JP)

(72) Inventors: Shuji KAWAI, Tokyo (JP); Tadanari HIGUCHI, Gifu (JP); Keisuke TOJI, Tokyo (JP); Takuya HORI, Tokyo (JP)

(21) Appl. No.: 18/879,217

(22) PCT Filed: Jun. 28, 2023
(86) PCT No.: PCT/JP2023/024019

§ 371 Date: Dec. 26, 2024

(30) Foreign Application Priority Data
Jun. 30, 2022 (JP) 2022-105543

(51) Int. Cl. G06Q 10/083; G06Q 30/0207

(52) U.S. Cl. CPC G06Q 10/0841; G06Q 30/0207

(57) ABSTRACT

An information processing system includes a notification unit that notifies a recipient who receives a package, of reference information regarding a package of another recipient corresponding to registration information that is registered in advance by the recipient.

### FIELD

The present invention relates to an information processing system, an information processing device, an information processing method, and a program.

### BACKGROUND

In recent years, technologies have been developed in regard to delivery work for delivery or collection of packages requested by a certain user, which enables a delivery person responding to the delivery work to efficiently deliver or collect the packages. For example, Patent Literature 1 discloses a technique that acquires the loading capacity of each of one or a plurality of circulation services circulating through three bases, and determines whether to change the operation plan of the circulation services based on the acquired loading capacity.

### CITATION LIST

### Patent Literature

Patent Literature 1: Japanese Patent Application Laid-open No. 2020-52525

### SUMMARY

### Technical Problem

However, with the technology described in Patent Document 1, a recipient designated in the address of a package may be required to receive the package at the delivery destination of the package delivered by the circulation service. For example, when packages are to be delivered directly to the homes of clients, the burden on the delivery side is significant. Thus, as the number of small-lot deliveries increases in the future, delivery charges may become more expensive. In contrast, there may be a way to consolidate packages to a prescribed receiving place. In such a case, even if there is no other plans at the delivery destination to which a package is delivered, a recipient may need to go to the delivery destination of the package only to collect the package.

The present invention is designed in view of the aforementioned circumstances, and it is an object thereof to provide a new and improved information processing system, information processing device, information processing method, and program capable of further improving the convenience in receiving packages.

### Solution to Problem

In order to overcome such issues, one aspect of the present invention provides an information processing system including a notification unit that notifies a recipient who receives a package, of reference information regarding a package of another recipient corresponding to registration information that is registered in advance by the recipient.

Furthermore, in order to overcome such issues, another aspect of the present invention provides an information processing device including a notification unit that notifies a recipient who receives a package, of reference information regarding a package of another recipient corresponding to registration information that is registered in advance by the recipient.

In order to overcome such issues, still another aspect of the present invention provides an information processing method executed by a computer, the information processing method including notifying a recipient who receives a package, of reference information regarding a package of another recipient corresponding to registration information that is registered in advance by the recipient.

In order to overcome such issues, yet another aspect of the present invention provides a program causing a computer to execute a notification function that notifies a recipient who receives a package, of reference information regarding a package of another recipient corresponding to registration information that is registered in advance by the recipient.

### Advantageous Effects of Invention

As described above, it is possible with the present invention to further improve the convenience in receiving packages.

### BRIEF DESCRIPTION OF DRAWINGS

FIG. 1 is an explanatory diagram for describing an overview of an information processing system according to an embodiment.

FIG. 2 is an explanatory diagram for describing an example of a functional configuration of an information terminal 20 according to the present embodiment.

FIG. 3 is an explanatory diagram for describing an example of a functional configuration of a management server 30 according to the present embodiment.

FIG. 4 is an explanatory diagram for describing an example of a flow related to a collection proxy service according to the present embodiment.

FIG. 5 is an explanatory diagram for describing an example of notification related to availability of a proxy service according to the present embodiment.

FIG. 6 is an explanatory diagram for describing an example of operation processing of the management server 30 according to the present embodiment.

FIG. 7 is an explanatory diagram for describing an example of a hardware configuration of the management server 30 according to the present embodiment.

### DESCRIPTION OF EMBODIMENTS

The contents of an embodiment of the present invention will be listed and described. An information processing system and the like according to the embodiment has the following configurations.

### Item 1

An information processing system including
a notification unit that notifies a recipient who receives a package, of reference information regarding a package of another recipient corresponding to registration information that is registered in advance by the recipient.

### Item 2

The information processing system according to item 1, further including an acquisition unit that acquires identification information acquired by an authentication operation performed by the recipient when collecting the package, in which
the notification unit sends the reference information based on the identification information.

### Item 3

The information processing system according to item 2, further including an authorization unit that authorizes collection of the package of the other recipient in accordance with the reference information notified by the notification unit, when a proxy-service operation regarding a collection proxy service of the package of the other recipient is performed by the recipient.

### Item 4

The information processing system according to item 3, in which
the registration information includes information regarding an address of the recipient, and
the notification unit sends reference information regarding a package of another recipient having a proxy-service collection location registered within a prescribed range from the address of the recipient.

### Item 5

The information processing system according to item 4, in which the proxy-service collection location includes an address of the other recipient registered by the other recipient.

### Item 6

The information processing system according to item 5, in which
the registration information includes information regarding a proxy-service authorized person who is authorized for a collection proxy service of a package with the recipient, and
the notification unit sends reference information regarding a package of the proxy-service authorized person.

### Item 7

The information processing system according to item 1, in which the reference information includes weight or size of the package of the other recipient.

### Item 8

The information processing system according to item 5, in which the reference information includes route information or time information regarding required time from a location where the recipient collects the package of the other recipient to the proxy-service collection location.

### Item 9

The information processing system according to item 1, in which the reference information includes information regarding a reward offered to the recipient when the recipient undertakes collection as a proxy service.

### Item 10

The information processing system according to any one of items 3 to 6, further including a communication unit that transmits a proxy-service completion notification to a terminal used by the other recipient, when a proxy-service completion operation is performed by the recipient.

### Item 11

The information processing system according to item 10, in which the communication unit transmits, to the terminal used by the other recipient, a proxy-service execution notification indicating that collection of the package is undertaken as a proxy service, when the collection of the package of the other recipient is authorized by the authorization unit.

### Item 12

An information processing device including
a notification unit that notifies a recipient who receives a package, of reference information regarding a package of another recipient corresponding to registration information that is registered in advance by the recipient.

### Item 13

An information processing method executed by a computer, the information processing method including
notifying a recipient who receives a package, of reference information regarding a package of another recipient corresponding to registration information that is registered in advance by the recipient.

### Item 14

A program causing a computer to execute
a notification function that notifies a recipient who receives a package, of reference information regarding a package of another recipient corresponding to registration information that is registered in advance by the recipient.

Hereinafter, a preferable embodiment of the present invention will be described in detail with reference to the accompanying drawings. In the present specification and drawings, duplicate explanations of structural components having substantially identical functional configuration will be omitted by applying the same reference signs thereto.

Furthermore, in the present specification and drawings, mobile bodies used by delivery persons are distinguished as necessary into each mobile body, such as a manned mobile body 10A and an unmanned vehicle 10B that moves under autonomous control or by remote control. However, when there is no particular need to distinguish the mobile bodies, each mobile body is simply referred to as a mobile body 10. Also, information terminals are distinguished as necessary into each information terminal, such as a delivery person terminal 20A that is used by a delivery person who delivers or collects packages and a recipient terminal 20B that is used by a recipient who receives delivered packages. However, when there is no particular need to distinguish the information terminals, each information terminal is simply referred to as an information terminal 20.

### 1. Overview of Information Processing System

One embodiment of the present invention relates to an information processing system that can further improve convenience for the recipient in receiving packages.

### <1.1. Overview>

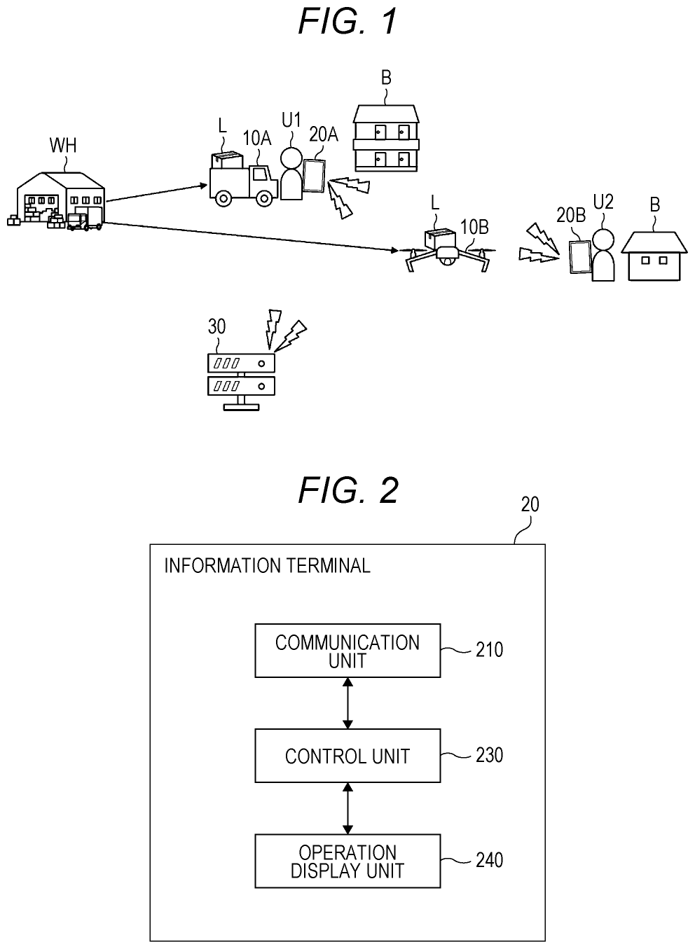

FIG. 1 is an explanatory diagram for describing an overview of the information processing system according to the present embodiment. As illustrated in FIG. 1, for example, the information processing system according to the present embodiment includes mobile bodies 10, information terminals 20, and a management server 30.

The mobile bodies 10, the information terminals 20, and the management server 30 are connected to each other via a network.

### (Mobile Body 10)

The mobile body 10 according to the present embodiment is a mobile body used in delivery work such as delivery or collection of a package L. For example, the mobile body 10 is used when delivering the package L requested to be delivered by a recipient U2 from a warehouse WH where the package L is stored. Note that the mobile body 10 is not essential in the delivery work, and the delivery may be made on foot along with a cart (for example, a box cart, a basket cart, or the like), for example.

For example, the mobile body 10 includes a manned mobile body 10A used by a delivery person U1 who delivers or collects the package L.

For example, the manned mobile body 10A according to the present embodiment may be a vehicle (for example, a passenger car, a light truck, a cargo vehicle such as a light van, a motorcycle, a bicycle, a kickboard, or the like) that travels on a land route, as illustrated in FIG. 1. However, the manned mobile body 10A is not limited to a vehicle. For example, the manned mobile body 10A may be an aircraft that flies on an air route, or a vessel moving along a waterway such as a seaway or a river.

Furthermore, the mobile body 10 according to the present embodiment includes an unmanned vehicle 10B that moves under autonomous control or by remote control. For example, the unmanned vehicle 10B may move by autonomous control using input information such as locations of two points such as a start point (for example, the delivery start location of the package L or the moving start location of the unmanned vehicle 10B) and an end point (for example, the receiving location of the package L), or locations of three or more points further including a relay point (for example, the collection location of the package L in case of delivery involving collection of the package L) and a return point (for example, the same location as the moving start location of the unmanned vehicle 10, or a different standby location and the like). Note that the input information used for autonomous control may include various kinds of information such as other via points and delivery routes.

The unmanned vehicle 10B may also be moved by remote control using operation information remotely input by an administrator who manages the unmanned vehicle 10B.

For example, the unmanned vehicle 10B may be an aircraft as illustrated in FIG. 1. For example, the aircraft may be a drone that flies under autonomous control or an unmanned aerial vehicle (UAV) that flies under remote control of an administrator.

The unmanned vehicle 10B according to the present embodiment is not limited to an aircraft. For example, the unmanned vehicle 10B may be an unmanned ground vehicle (UGV) or the like that travels on a land route, or it may be a vessel traveling on a waterway, such as a seaway or a river.

The manned mobile body 10A and the unmanned vehicle 10B may also be mobile bodies that can travel on at least two or more routes out of land route, waterway, and air route.

### (Information Terminal 20)

The information terminal 20 according to the present embodiment is a terminal used by parties involved in services related to delivery or collection. For example, the information terminal 20 may be any of various kinds of terminals such as a tablet terminal, a smartphone, a cellular phone, a personal handy-phone system (PHS), a personal digital assistant (PDA), a personal computer (PC), or the like.

The information terminal 20 includes a delivery person terminal 20A used by the delivery person U1 who delivers or collects the package L. For example, the delivery person U1 may use the delivery person terminal 20A to check delivery instruction information including a delivery task based on the request details included in a delivery request registered by the recipient U2. In FIG. 1, the package L is delivered to the recipient U2 who makes the delivery request. However, it is not limited to such cases, and it may also be a package that is sent by a client as a sender and delivered to a recipient different from that client. In such a case, the delivery person U1 loads the package L onto the mobile body 10 or the like when leaving the warehouse WH or the like, and one or more delivery tasks may also be set in advance as a delivery plan in a prescribed order. Note here that the delivery instruction information includes various kinds of information used for delivery of the package L, such as information on the package delivery destination (for example, the package receiving location of the recipient U2).

The information terminal 20 also includes a recipient terminal 20B used by the recipient U2 who receives the delivered package L. For example, the recipient U2 may use the recipient terminal 20B to check a delivery completion notification indicating that the delivery of the package L to be received by the recipient U2 (for example, delivery to a storage place, delivery to a delivery box in an apartment, or the like) is completed. The storage place can also be considered a receiving place for the recipient when going there to receive the own package. However, when a package of another recipient is to be received as well, it can be a temporary storage place for the other recipient as a result.

Furthermore, the recipient terminal 20B may display reference information regarding a package of another recipient delivered by the delivery person U1 or the unmanned vehicle 10B. While the details of the reference information will be described later, the reference information may include information on the weight or size of the package L of another recipient, for example, and the recipient U2 may check the reference information and consider whether to collect the package on behalf of another recipient.

### (Management Server 30)

The management server 30 according to the present embodiment is an example of the information processing device, and it is a server that performs management related to receiving the package L. For example, the management server 30 may be a general-purpose computer such as a workstation or a PC, or may also be a cloud server.

The management server 30 notifies the recipient U2 of the reference information regarding the packages of other recipients corresponding to registration information that is registered in advance by the recipient U2 who receives the package L.

For example, the management server 30 may notify the recipient U2 who receives the package L, of the reference information regarding a package of another recipient for which a receiving place (for example, home delivery box or the like) is set within a prescribed range from the address of the home or the like of the recipient U2 registered by the recipient U2 or regarding a package of another recipient for which a receiving place is set within a prescribed range from a route from the receiving place of the recipient U2 to the address of the home thereof or the like.

The management server 30 may also notify the recipient U2 of the reference information regarding the package of the other recipient based on identification information of the recipient U2. Then, the recipient U2 upon checking the reference information considers whether to collect the package on behalf of another recipient.

When collecting the package on behalf of another recipient, the recipient U2 performs a proxy-service operation related to a collection proxy service of the package. When a proxy-service operation is performed, the management server 30 may authorize the recipient U2 to collect the package of another person. Furthermore, when a proxy-service operation is performed, the management server 30 may request permission from the other recipient for the recipient U2 to undertake the proxy service and, upon receiving a permission signal, may authorize the recipient U2 to collect the package of the other recipient.

For example, the package of the other recipient may be held in a holding device described below. Here, when there is a proxy-service operation regarding the collection proxy service of the package of the other recipient performed by the recipient U2, the management server 30 may transmit a control signal to the holding device to release the package of the other recipient. This enables the recipient U2 to collect the package of the other recipient and deliver the package to a proxy-service receiving location (for example, home or the like of the other recipient) registered by the other recipient. In a case where the package of the other recipient is managed by a package manager, the management server 30 may transmit, to a package manager terminal owned by the package manager, information indicating that the collection proxy service of the package of the other recipient by the recipient U2 is authorized. Then, for allowing the package manager to make confirmation, the management server 30 may transmit information (including, for example, a textual description or identification information acquired through an authentication operation described below) to the recipient terminal 20B indicating that it is the recipient authorized to undertake a collection proxy service of the package of the other recipient.

The overview of the information processing system according to the present embodiment is described heretofore. Subsequently, examples of the functional configurations of the information terminal 20 and the management server 30 according to the present embodiment will be described in order.

### 2. Example of Functional Configuration

### <2.1. Example of Functional Configuration of Information Terminal 20>

FIG. 2 is an explanatory diagram for describing an example of the functional configuration of the information terminal 20 according to the present embodiment. As illustrated in FIG. 2, the information terminal 20 according to the present embodiment includes a communication unit 210, a control unit 230, and an operation display unit 240.

### (Communication Unit 210)

The communication unit 210 according to the present embodiment performs various kinds of communication with the management server 30. For example, the communication unit 210 provided to the recipient terminal 20B may receive, from the management server 30, reference information regarding a package of another recipient corresponding to registration information registered in advance by a recipient.

For example, the communication unit 210 may transmit, to the management server 30, identification information acquired through an authentication operation performed by a recipient when collecting the package of the recipient. In this case, the communication unit 210 may receive, from the management server 30, the reference information that is transmitted in accordance with the identification information.

The authentication operation includes, for example, an operation in which the identification information is read out by an input device such as a camera. More specifically, the authentication operation includes an operation in which various kinds of information codes, such as a bar code or two-dimensional code displayed or printed on the package or on the holding device that stores the package, are read out by the camera as the identification information. Note that the holding device may be a storage box, for example, or the unmanned vehicle 10B. The holding device may also be a device that is capable of securing the package L by a fixture such as a belt, a frame, or the like.

The authentication operation may also include an operation in which the identification information of the package or holding device is read out by the recipient through the use of a contactless or contact-type IC card reader or the like by the recipient. The authentication operation may also include an operation in which the identification information is input by the recipient using the operation display unit 240. In this case, the identification information includes a string of characters displayed or printed on the package or the holding device, for example.

The authentication operation may also include an operation in which the external shape of the package or the holding device is read out. In this case, the communication unit 220 transmits the read external shape to the management server 30 as an image, and the management server 30 may convert the image into identification information through image recognition.

### (Control Unit 230)

The control unit 230 controls the overall operation of the information terminal 20. For example, the control unit 230 may control transmission of identification information by the communication unit 210. The control unit 230 may also control the display of reference information using the operation display unit 240.

### (Operation Display Unit 240)

The operation display unit 240 according to the present embodiment has a function as an operation unit for performing operations to input the request details related to delivery or collection of a package. The operation display unit 240 also has a function as a display unit for displaying reference information received from the management server 30.

The function as the operation unit can be achieved, for example, by a touch panel or a keyboard, for example. Furthermore, the function as the display unit can be achieved by a cathode ray tube (CRT) display device, a liquid crystal display (LCD), or an organic light emitting diode (OLED) device. Note that the function as the display unit and the function as the operation unit may be configured separately.

Note that the information terminal 20 may include a microphone, not illustrated in FIG. 2. In that case, the recipient may use the microphone to voice-input the identification information. The information terminal 20 may further include a speaker, not illustrated in FIG. 2. In that case, the delivery person may check the reference information by the voice output from the speaker.

### <2.2. Example of Functional Configuration of Management Server 30>

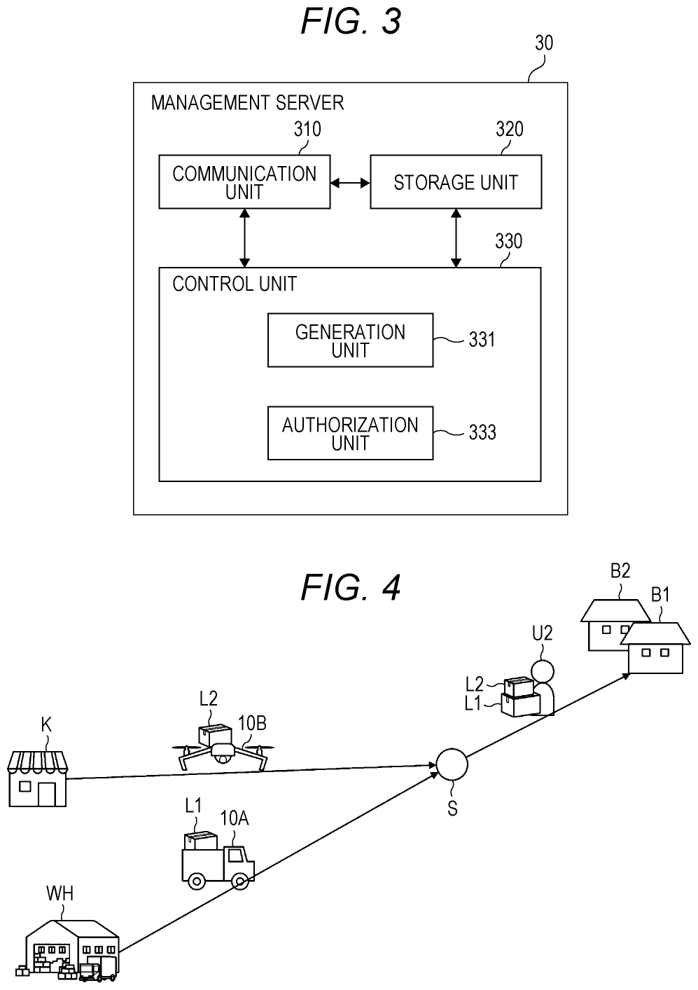

FIG. 3 is an explanatory diagram for describing an example of the functional configuration of the management server 30 according to the present embodiment. The management server 30 according to the present embodiment includes a communication unit 310, a storage unit 320, and a control unit 330, as illustrated in FIG. 3.

### (Communication Unit 310)

The communication unit 310 according to the present embodiment performs various kinds of communication with the information terminal 20. For example, the communication unit 310 is an example of a notification unit and transmits, to the recipient terminal 20B, reference information regarding a package of another recipient corresponding to registration information that is registered in advance by a recipient who receives a package.

Furthermore, the communication unit 310 is an example of an acquisition unit, and receives identification information from the recipient terminal 20B. For example, the communication unit 310 may transmit reference information generated by a generation unit 331 described below, after receiving the identification information from the recipient terminal 20B.

However, the timing at which the reference information is transmitted by the communication unit 310 may not necessarily be after the communication unit 310 receives the identification information from the recipient terminal 20B. For example, the communication unit 310 may transmit, to the recipient terminal 20B, reference information regarding the package of the other recipient corresponding to registration information of the recipient, regardless of whether identification information is received. This allows the recipient to check the reference information on the way to the receiving location of the package.

The communication unit 310 may also transmit the reference information regarding the package of the other recipient generated by the generation unit 331 to the holding device (for example, the storage box or the unmanned vehicle 10B) that is holding the package. In this case, the storage box or the unmanned vehicle 10B upon receiving the reference information may notify the recipient of the reference information by having the received reference information output to an output device such as a display.

The communication unit 310 may also transmit control information that enables collection of the package of the recipient or the package of the other recipient authorized by an authorization unit 333 described below to the holding device such as the storage box or the unmanned vehicle 10B that is holding the package. Furthermore, when a proxy-service operation is performed, the communication unit 310 may request permission from the other recipient for the recipient U2 to undertake the proxy service and, upon receiving a permission signal, may authorize the recipient U2 to collect the package of the other recipient. In a case where the package of the other recipient is managed by the package manager, the communication unit 310 may transmit, to the package manager terminal owned by the package manager, information indicating that the collection proxy service of the package of the other recipient by the recipient U2 is authorized. Then, for allowing the package manager to make confirmation, the communication unit 310 may transmit information (including, for example, a textual description or identification information acquired through an authentication operation described below) to the recipient terminal 20B indicating that it is the recipient authorized to undertake a collection proxy service of the package of the other recipient.

### (Storage Unit 320)

The storage unit 320 according to the present embodiment holds software and various kinds of data. For example, the storage unit 320 stores registration information that is stored in advance by the recipient. For example, the storage unit 320 stores recipient information that is the information of the recipient. Recipient information includes, for example, various kinds of basic information such as the name of the recipient, the recipient name within the service, identification information of the recipient, information on proxy service authorized person, e-mail address, address, or telephone number, as well as information such as account information of an external application and payment information (credit card information or the like).

The recipient information may also include information related to receiving the package, such as the receiving location of the package. For example, the receiving location of the package may be set to a different location for each of the case of collecting own package by oneself and the case of collecting the package by a proxy service.

For example, a certain store, a bus stop, or other stops may be set as a receiving location of a package when a recipient collects the package of the recipient. In the meantime, a delivery box placed at the home of the recipient may be set as the receiving location of a package when the package is collected by another recipient by a proxy service. In this case, the other recipient stores the package of the recipient collected by a proxy service at a store, a bus stop, or other stops in the delivery box set by the recipient. The receiving location of the package when the package is collected by the other recipient by a proxy service is an example of a proxy-service collection location.

Furthermore, the storage unit 320 also stores information regarding the package addressed to the recipient that uses the recipient terminal 20B. The information regarding the package includes, for example, identification information of the package, size of the package, weight of the package, scheduled arrival time of the package, characteristics of the package, delivery means of the package, and the like. The information regarding the package L may also include attention-point information of the package. Note that the attention-point information of the package may include information regarding handling of the package, such as whether it is a frozen product, to store it with the right side up, not to have anything stacked above, perishable, fragile article, and the like.

Furthermore, the identification information of the recipient is identification information for uniquely identifying the recipient who uses the recipient terminal 20B (hereinafter, referred to as “recipient ID”), and the identification information of the package is identification information for uniquely identifying the package (hereinafter, referred to as “package ID”).

The storage unit 320 holds the package ID in association with the recipient ID of the recipient designated in the address of the package indicated by the package ID.

### (Control Unit 330)

The control unit 330 according to the present embodiment controls the overall operation of the management server 30. As illustrated in FIG. 3, the control unit 330 includes a generation unit 331 and an authorization unit 333.

The generation unit 331 according to the present embodiment generates the reference information regarding the package of the other recipient corresponding to the registration information that is registered in advance by the recipient who receives the package.

The generation unit 331 may generate the reference information regarding the package of the other recipient corresponding to the registration information that is registered in advance by the recipient who receives the package, based on the identification information received by the communication unit 310, for example.

For example, the generation unit 331 may also generate the reference information based on the information of the recipient indicated by the recipient ID that is associated with the identification information (package ID) received by the communication unit 310. More specifically, the generation unit 331 may generate the reference information regarding a package of another recipient for which a proxy-service receiving location is set within a prescribed range from the address of the home or the like of the recipient included in the information of the recipient, or regarding a package of another recipient for which a receiving place is set within a prescribed range from a route from a receiving place of the recipient U2 to the address of the home or the like. In a case where the address of the other recipient is registered as the proxy-service collection location of the other recipient, the recipient can collect packages on behalf of neighbors who live in the same apartment or neighboring houses, thereby making it possible to reduce the burden or the like on the delivery person going to individual houses and the burden on the recipient related to a package collection proxy service.

The generation unit 331 may also generate the reference information of the package of the other recipient based on the information of the proxy service authorized person included in the information of the recipient. For example, the recipient may register relatives, friends, or the like as the proxy-service authorized person. In this case, the generation unit 331 may generate reference information of a package of another recipient registered as the proxy service authorized person. Note that, when there is an operation made by a prospective registrant (for example, a relative, friend, or the like) designated by the recipient for permitting to be registered as the proxy service authorized person of the recipient, the management server 30 may register the registrant as the proxy service authorized person of the recipient. In addition, it is more preferable for the reference information regarding other recipients than the proxy service authorized person to include at least receiving place information but not the name of the recipient or the recipient name in the service. However, for the proxy service authorized person, in addition to or instead of the name of the receiving place information, at least the recipient or the recipient name in the service may be included.

When a proxy-service operation related to a collection proxy service of a package of another recipient is performed by a recipient in accordance with the reference information notified by the generation unit 331, the authorization unit 333 according to the present embodiment authorizes collection of the package of the other recipient.

For example, when collection of the package of the other recipient is authorized by the authorization unit 333, the communication unit 310 may transmit, to the recipient terminal 20B used by the other recipient, a proxy-service execution notification indicating that the package is collected by a proxy service.

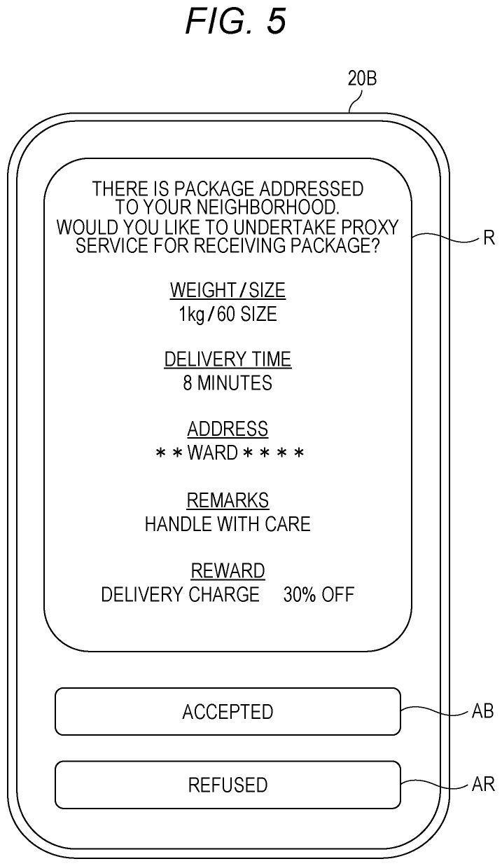

Furthermore, when collection of the package of the other recipient is authorized by the authorization unit 333, the communication unit 310 may transmit, to the holding device that holds the package, a control signal for giving an instruction to transition to a state where the package can be collected from the holding device. Alternatively, when the package of the other recipient is managed by the package manager, the communication unit 310 may transmit, to the package manager terminal owned by the package manager, information indicating that the collection proxy service of the package of the other recipient by the recipient U2 is authorized. Then, for allowing the package manager to make confirmation, the communication unit 310 may transmit information (including, for example, a textual description or identification information acquired through an authentication operation) to the recipient terminal 20B indicating that it is the recipient authorized to undertake a collection proxy service of the package of the other recipient. This allows the package manager to check which package is the package for the recipient, either by visual recognition or by reading out the identification information or the like using a reader terminal. Referring now to FIG. 4 and FIG. 5, an example of a flow related to a collection proxy service in which a recipient collects a package on behalf of another recipient will be described.

First, a recipient accesses the management server 30 using an application (including a web browser) or the like. When it is the first time to use the service, the recipient may go through usage registration processing and acquire account information including the recipient ID and the like. The recipient upon acquiring the account information and the recipient who has already acquired account information may then start using the service by logging in after receiving a prescribed authentication by inputting the recipient ID and password, for example. Instead of the account information, the use of the service may be started by inputting a unique application ID associated with the application downloaded to the recipient terminal 20B as the recipient ID, or may be started by using other authentication methods.

FIG. 4 is an explanatory diagram for describing an example of a flow related to the collection proxy service according to the present embodiment. FIG. 4 describes an example in which a bus stop S is designated as the receiving location of a package L1 and a package L2. When there is no particular need to distinguish between those, the package L1 and the package L2 may be collectively referred to as the package L.

Furthermore, a storage box capable of storing the package L is placed at the bus stop S as a holding device. Note, however, that the package L may be held by other holding devices than the storage box.

First, the recipient U2 registers a delivery request for the package L1. Subsequently, a delivery person responding to the delivery request uses the manned mobile body 10A (for example, a vehicle as illustrated in FIG. 4) to deliver the package L1 from the warehouse WH where the package L1 is stored to the bus stop S, and stores the package L1 in the storage box placed at the bus stop S.

At this time, the delivery person upon delivering the package L1 may use the delivery person terminal 20A or the storage box to perform an input operation related to the completion of delivery. When the input operation related to the completion of delivery is performed by the delivery person, the management server 30 may transmit a notification related to the completion of delivery to the recipient terminal 20B of the recipient U2, which is associated with the identification information of the package L1.

The recipient U2 upon checking the notification related to the completion of delivery of the package L1 then performs an authentication operation related to collection of the package L at the bus stop S that is the receiving location of the package L1. At this time, when the package L2 of another recipient satisfying certain criteria is stored in the storage box, the reference information regarding the package L2 of the other recipient may be notified to the recipient U2.

Note here that the other recipient satisfying certain criteria is the other recipient corresponding to the registration information of the recipient U2 as described above, including, for example, the other recipient who has registered, in recipient information, the address of residence B2 that is located within a prescribed range from the address of home B1 of the recipient U2.

For example, the package L2 of the other recipient is delivered by the unmanned vehicle 10B from a store K that handles the package L2 to the bus stop S, and stored in the storage box placed at the bus stop S.

In such a situation, the communication unit 310 transmits, to the recipient terminal 20B of the recipient U2, a notification related to the acceptability of the proxy service, including reference information regarding the package L2 of the other recipient generated by the generation unit 331. The recipient U2 then considers whether to undertake a collection proxy service of the package L2 of the other recipient, based on a notification screen displayed on the operation display unit 240 provided to the recipient terminal 20B.

FIG. 5 is an explanatory diagram for describing an example of a notification screen related to the availability of the proxy service according to the present embodiment. For example, the operation display unit 240 provided to the recipient terminal 20B displays a notification screen related to the availability of the proxy service, as illustrated in FIG. 5, for example.

Note here that the notification screen includes reference information R regarding a package of another recipient, an approval button AB, and a refusal button AR, as illustrated in FIG. 5, for example.

The reference information R regarding the package of the other recipient may include, as illustrated in FIG. 5, for example, a message for checking whether to accept reception of the package by a collection proxy service, information regarding the weight and size of the package of the other recipient, information regarding the time required from the location where the package of the other recipient is collected to the proxy-service collection location set by the other recipient, information regarding the proxy-service collection location of the other recipient, remarks information regarding the package of the other recipient, and information regarding the reward.

The information regarding the weight and size of the package of the other recipient includes information indicating the weight of the package of the other recipient (for example, “1 kg” illustrated in FIG. 5) and information indicating the size of the package (for example, “60 size” illustrated in FIG. 5). However, the units of weight and size are not limited to those in the example indicated in FIG. 5. For example, the size of the package may be in other units of volume, such as cubic meters. Furthermore, the information regarding the size of the package of the other recipient may be a video with which the size of the package can be recognized.

The information regarding the time required from the location where the package of the other recipient is collected to the proxy-service collection location set by the other recipient is, for example, the time required from the location of the storage box where the package of the other recipient is stored to the proxy-service collection location of the other recipient (for example, the home of the other recipient). The time required may be determined in accordance with travel means of the recipient (walking, bicycle, car, or the like), for example.

The information regarding the proxy-service collection location of the other recipient may be the address of the home registered by the other recipient as the proxy-service collection location, as indicated in FIG. 5, for example. Furthermore, the information regarding the proxy-service collection location of the other recipient may be route information from the location where the package of the other recipient is collected to the proxy-service collection location set by the other recipient.

Remarks information regarding the package of the other recipient may be attention-point information such as handle with care as indicated in FIG. 5, or other information that can be utilized for considering the proxy service, such as the time of absence of the other recipient.

The information regarding the reward includes information for notifying the recipient of the reward for the recipient when collecting the package on behalf of the other recipient. As an example of the reward, FIG. 5 illustrates a reward that is to reduce the delivery charge for the package of the recipient. However, the reward is not limited to such an example. For example, the reward may be money, a service, points of monetary value, or the like. Note that the content of the reward may be determined by the other recipient or may be a prescribed content (for example, common reward content, or reward content according to the results of previous proxy collection services, reward content according to the information related to the package such as the weight or the like of the package, or the like).

The recipient upon checking the reference information R as described above considers whether to collect the package on behalf of the other recipient. Then, the recipient may select the refusal button AR, when not accepting the collection proxy service of the package for the other recipient. In this case, the recipient collects only the own package without collecting the package of the other recipient stored in the storage box.

In the meantime, the recipient may select the approval button AB, when accepting the collection proxy service of the package for the other recipient. In this case, the authorization unit 333 determines that a proxy-service operation regarding the collection proxy service of the package is performed, and authenticates the collection of the package of the other recipient.

Then, the communication unit 310 transmits a control signal to the holding device for enabling the recipient to collect the package of the other recipient. More specifically, when the holding device is a storage box, the communication unit 310 may transmit a control signal to the storage box to open the door of the storage box in which the package of the other recipient is stored. Then, when the storage box upon receiving the control signal opens its door, the recipient can collect the package of the other recipient.

For example, when collection of the package of the other recipient is authorized by the authorization unit 333, the communication unit 310 may transmit, to the recipient terminal 20B of the other recipient, a proxy-service execution notification indicating that the package is delivered by a proxy service. This allows the other recipient to know that the own package is being delivered by others, which makes it possible to reduce the occurrence of miscommunication where the own package has already been collected by others by a proxy service when arriving at the storage box.

Then, as illustrated in FIG. 4, the recipient U2 collects the own package L1 and the package L2 of the other recipient that are set to be collectable from the storage box, and delivers the package L2 to the residence B2 that is the proxy-service collection location registered by the other recipient.

The recipient U2 may then store the package L2 of the other recipient in the delivery box at the residence B2, and use the recipient terminal 20B to perform a proxy-service completion operation related to the collection proxy service on the application (for example, selecting a button indicating completion of the proxy service). In a case of a storage space such as a type of delivery box for which an arbitrary password is set, for example, the proxy-service completion operation may also include an operation for inputting information regarding the set password.

When the proxy-service completion operation is performed, the communication unit 310 may transmit, to the recipient terminal 20B of the other recipient, a proxy-service completion notification indicating that the package is stored in the delivery box at the residence B2. Thereby, the recipient U2 completes a series of flows from undertaking the proxy service for collecting the package to passing on the package.

Note that the information included in the reference information is not limited to the example indicated in FIG. 5. For example, the reference information may not include some of the information indicated in FIG. 5, or it may include other information that may be reference when undertaking the collection proxy service. For example, there may be no reward when a recipient collects a package on behalf of the other recipient. In this case, the reference information does not contain information regarding the reward.

Furthermore, the recipient U2 may not necessarily need to deliver the package of the other recipient to the location set as the proxy-service collection location. For example, for a relative, friend, or the like registered as a proxy-service authorized person, the recipient U2 may pass on a package of the proxy-service authorized person directly to the proxy-service authorized person. The recipient U2 may also pass on the package of the proxy-service authorized person to the proxy-service authorized person via another user. In this case, however, it is desirable for the recipient U2 to acquire authentication from the proxy-service authorized person and another user in advance. For example, information regarding which reception type to be used may be set in the information of the proxy-service authorized person, or an approval operation may include that the other recipient designates it at the time of approval for making a proxy-service request or that a receiving method designated by a recipient is also approved.

Furthermore, when an operation regarding the proxy-service authentication is acquired from the other recipient whose package is to be collected by a proxy service, the authorization unit 333 may authorize the recipient to collect the package of the other recipient. For example, the recipient upon checking the information including the reference information contacts the other recipient by any communication means. The other recipient may then perform an operation related to a proxy-service permission using the recipient terminal 20B of the other recipient.

Furthermore, when the delivery box of the other recipient is full, the recipient U2 may drop the package of the other recipient at the home of the other recipient. In particular, the package may be dropped at an alternative receiving place by referring to alternative receiving place information set in advance by the other recipient. The alternate receiving place information may be, for example, information indicating the parking location such as a parking lot or a bicycle parking lot, information indicating a room number, or the like.

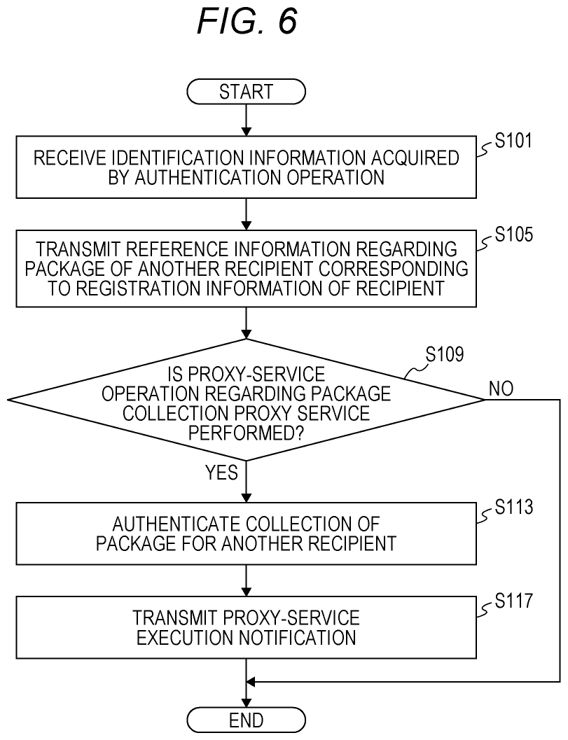

According to the collection proxy service described above, a recipient can collect a package on behalf of the other recipient while collecting the own package. As a result, for example, it is possible to reduce the time and effort required for the other recipient to go to the receiving location only to collect the package of the other recipient oneself, which makes it possible to further improve convenience for the recipients in receiving packages. Referring now to FIG. 6, an example of operation processing of the management server 30 according to the present embodiment will be described.

### 3. Operation Processing Example

FIG. 6 is an explanatory diagram for describing an example of the operation processing of the management server 30 according to the present embodiment. First, the communication unit 310 receives identification information acquired through an authentication operation from the recipient terminal 20B (S101).

Then, the generation unit 331 generates the reference information regarding the package of the other recipient corresponding to the registration information that is registered in advance by a recipient corresponding to the acquired identification information, and the communication unit 310 transmits the reference information to the recipient terminal 20B (S105).

Then, the control unit 330 determines whether a proxy-service operation regarding a collection proxy service of the package is performed (S109). When determined that a proxy-service operation regarding a collection proxy service of the package is performed (Yes at S109), the processing is proceeded to S113. When determined that no proxy-service operation regarding a collection proxy service of the package is performed (No at S109), the management server 30 according to the present embodiment ends the processing.

When determined that a proxy-service operation regarding a collection proxy service of the package is performed (Yes at S109), the authorization unit 333 authenticates collection of the package of the other recipient by the recipient, and the communication unit 310 transmits, to the storage box where the package is stored, a control signal that enables the package of the other recipient to be collected (S113).

The communication unit 310 then transmits a proxy-service execution notification notifying that the package is collected by a proxy service to the recipient terminal 20B of the other recipient whose package is collected by the proxy service, and the management server 30 according to the present embodiment ends the processing.

### 4. Hardware Configuration Example

The information processing described above is achieved through cooperation of software and hardware of the management server 30 described below. Note that the hardware configuration described below is also applicable to the information terminal 20.

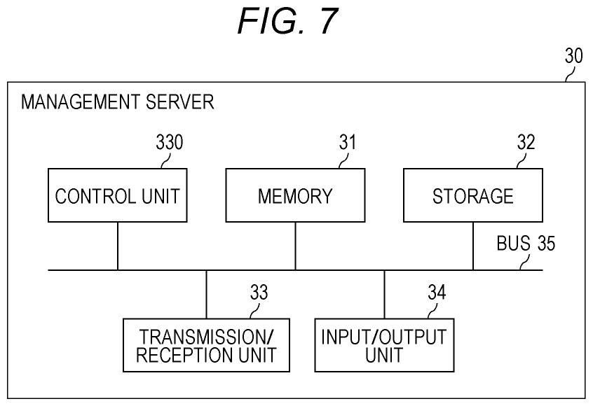

FIG. 7 is an explanatory diagram for describing an example of the hardware configuration of the management server 30 according to the present embodiment. As illustrated in FIG. 7, for example, the management server 30 includes a control unit 330, a memory 31, a storage 32, a transmission/reception unit 33, an input/output unit 34, and the like, which are electrically connected to each other via a bus 35.

The control unit 330 is an arithmetic device that controls the overall operation of the management server 30, controls transmission and reception of data between each of the elements, executes applications, and performs information processing and the like necessary for authentication processing. For example, the control unit 330 is a central processing unit (CPU) and/or a graphics processing unit (GPU), which executes programs and the like for the system stored in the storage 32 and expanded on the memory 31 to perform various kinds of information processing as described above.

The memory 31 includes a main memory that is configured with a volatile storage device such as dynamic random access memory (DRAM) or the like, and an auxiliary memory that is configured with a non-volatile storage device such as a flash memory, a hard disc drive (HDD), or the like. The memory 31 is used as a work area and the like of the control unit 330, and also stores the basic input/output system (BIOS) executed when starting the management server 30 as well as various kinds of setting information and the like.

The storage 32 stores various kinds of programs such as application programs and the like. A database that stores the data used for each kinds of processing may be built in the storage 32.

The transmission/reception unit 33 connects the management server 30 to the network and/or blockchain network. Note that the transmission/reception unit 33 may include near field communication interfaces of Bluetooth (registered trademark) and Bluetooth Low Energy (BLE).

The input/output unit 34 is an information input device such as a keyboard, a microphone, a mouse, and the like and an output device such as a display, a speaker, and the like.

The bus 35 is commonly connected to each of the above elements and transmits, for example, address signals, data signals, and various kinds of control signals.

### 5. Supplement

The preferable embodiment of the present invention is described above in detail with reference to the accompanying drawings. However, the present invention is not limited to such examples. It is readily apparent to those having ordinary knowledge and skilled in the art to which the present invention belongs that various modifications and substitutions can be made without departing from the technical spirit and scope of the appended claims, and that those naturally fall within the technical scope of the present invention.

For example, while the present specification mainly describes an example in which a delivery person uses the mobile body 10 to deliver the package, the delivery person does not necessarily need to use the mobile body 10. For example, the delivery person may deliver the package on foot.

The recipient may also be another delivery person (for example, a delivery person, a gig worker, or the like). In this case, the package L may be passed from the unmanned vehicle 10B to another delivery person at a certain receiving location. Then, another delivery person upon receiving the package L may deliver the package L to the proxy-service collection location registered by the recipient.

It is also possible to create a computer program for causing hardware such as a CPU, a ROM, a RAM, and the like built into the information terminal 20 and the management server 30 to achieve the same functions as those of the information terminal 20 and the management server 30 described above.

### REFERENCE SIGNS LIST

10 Mobile body
20 Information terminal
210 Communication unit
230 Control unit
240 Operation display unit
30 Management server
310 Communication unit
320 Storage unit
330 Control unit
331 Generation unit
333 Authorization unit

1. An information processing system comprising
a notification unit that notifies a recipient who receives a package, of reference information regarding a package of another recipient corresponding to registration information that is registered in advance by the recipient.

2. The information processing system according to claim 1, further comprising an acquisition unit that acquires identification information acquired by an authentication operation performed by the recipient when collecting the package, wherein
the notification unit sends the reference information based on the identification information.

3. The information processing system according to claim 2, further comprising an authorization unit that authorizes collection of the package of the other recipient in accordance with the reference information notified by the notification unit, when a proxy-service operation regarding a collection proxy service of the package of the other recipient is performed by the recipient.

4. The information processing system according to claim 3, wherein
the registration information includes information regarding an address of the recipient, and
the notification unit sends reference information regarding a package of another recipient having a proxy-service collection location registered within a prescribed range from the address of the recipient.

5. The information processing system according to claim 4, wherein the proxy-service collection location includes an address of the other recipient registered by the other recipient.

6. The information processing system according to claim 5, wherein
the registration information includes information regarding a proxy-service authorized person who is authorized for a collection proxy service of a package with the recipient, and
the notification unit sends reference information regarding a package of the proxy-service authorized person.

7. The information processing system according to claim 1, wherein the reference information includes weight or size of the package of the other recipient.

8. The information processing system according to claim 5, wherein the reference information includes route information or time information regarding time required from a location where the recipient collects the package of the other recipient to the proxy-service collection location.

9. The information processing system according to claim 1, wherein the reference information includes information regarding a reward offered to the recipient when the recipient undertakes collection as a proxy service.

10. The information processing system according to claim 3, further comprising a communication unit that transmits a proxy-service completion notification to a terminal used by the other recipient, when a proxy-service completion operation is performed by the recipient.

11. The information processing system according to claim 10, wherein the communication unit transmits, to the terminal used by the other recipient, a proxy-service execution notification indicating that collection of the package is undertaken as a proxy service, when the collection of the package of the other recipient is authorized by the authorization unit.

12. An information processing device including
a notification unit that notifies a recipient who receives a package, of reference information regarding a package of another recipient corresponding to registration information that is registered in advance by the recipient.

13. An information processing method executed by a computer, the information processing method including
notifying a recipient who receives a package, of reference information regarding a package of another recipient corresponding to registration information that is registered in advance by the recipient.

14. A program causing a computer to execute
a notification function that notifies a recipient who receives a package, of reference information regarding a package of another recipient corresponding to registration information that is registered in advance by the recipient.
